(19) United States
(12) Patent Application Publication
(10) Pub. No.: US 2013/0011108 A1
(43) Pub. Date: Jan. 10, 2013

(54) UV Curable Acrylate Buffer Coating for Optical Fiber

(75) Inventors: Peter A. Weimann, Atlanta, GA (US); Timothy Goddard, Newnan, GA (US); Heng Ly, Stone Mountain, GA (US)

(73) Assignee: OFS FITEL, LLC, Norcross, GA (US)

(21) Appl. No.: 13/177,107

(22) Filed: Jul. 6, 2011

(51) Int. Cl. G02B 6/036; B05D 5/06; C09D 4/00; C09D 175/16; C09D 4/02

(52) U.S. Cl. 385/128; 524/590; 524/539; 427/163.2

(57) ABSTRACT

Certain embodiments of the invention may include a UV curable acrylate buffer coating for optical fiber. According to an example embodiment of the invention, a buffered optical fiber is provided. The buffered optical fiber includes a core, a cladding surrounding the core, a primary layer surrounding the cladding, a secondary layer surrounding the primary layer. A clear or translucent buffer surrounds the optical fiber, wherein the buffer includes polyester/polyether polyol aliphatic urethane acrylate, and the buffer has an elastic modulus greater than 40,000 psi.

### FIELD OF THE INVENTION

This invention generally relates to optical fibers, and in particular to buffer coatings for optical fibers.

### BACKGROUND OF THE INVENTION

Optical fiber for interconnect cordage or certain bend-insensitive drop cable is often made with a tight buffer. Many of the commercially available UV-curable products that have been used for optical cable tight buffer applications tend to have low modulus, and are designed for flexibility and mechanical properties similar to PVC. Manufacturers including DSM, Hexion, and Herkula, offer such commercial products. Other extruded thermoplastic buffers have been used, including PVC compounds, nylon, polyester thermoplastic elastomers, and metal hydrate filled polyolefins.

An example of a basic tight buffer construction is disclosed in U.S. Pat. No. 5,684,910 to Chapin et al, and includes a dual-layer having an inner layer of ethylene-ethyl acrylate copolymer (E-EA) and an outer layer of Nylon 12. The high stiffness of the nylon buffer provides increasing mechanical reliability for use in jumpers and cables, and it helps resist buckling in repeated mating of optical connectors, especially pull-proof types such as ST II+ or LC connectors. The stiff buffer also results in low macrobending attenuation in ultra-bend-insensitive drop cables, as described in U.S. Pat. No. 7,817,892 to Konstadinidis et al.

Unfortunately, there are challenges and issues with ongoing production of this dual-layer tight buffer. First, fabrication of this tight buffer requires a capital-intensive, complicated co-extrusion process using two extruders. Second, the properties of the nylon limit line speed to approximately 140 meters per minute; at higher line speeds, it becomes difficult to achieve consistent dimensions or uniform surface finish. Third, when multiple buffers are required within a cable, they must be identified by using different color concentrates in the nylon layer. The buffer layer coloring process can be expensive, and changing between colors consumes time and creates scrap, as the extruder must be purged of the old color before the new color can be introduced.

### BRIEF SUMMARY OF THE INVENTION

Some or all of the above challenges and needs may be addressed by certain embodiments of the invention. Certain embodiments of the invention may include optical fibers having a UV curable acrylate buffer coating.

According to an example embodiment of the invention, a buffered optical fiber is provided. The buffered optical fiber may include a core, a cladding surrounding the core, a primary layer surrounding the cladding, a secondary layer surrounding the primary layer; and a clear or translucent buffer that surrounds the optical fiber, wherein the buffer includes polyester/polyether polyol aliphatic urethane acrylate, and wherein the buffer has an elastic modulus greater than 40,000 psi.

According to another example embodiment, an ultraviolet curing liquid coating composition is provided. The composition includes polyester/polyether polyol aliphatic urethane acrylate, which when cured with ultraviolet light in the presence of a photoinitiator sensitive to the ultraviolet light, provides a clear or translucent buffer coating for optical fiber comprising an elastic modulus greater than 40,000 psi.

According to another example embodiment, method is provided for coating an optical fiber. The method includes coating an optical fiber with a clear or translucent buffer, wherein the buffer includes polyester/polyether polyol aliphatic urethane acrylate, wherein the optical fiber includes a core, a cladding surrounding the core, a primary layer surrounding the cladding, a secondary layer surrounding the primary layer.

Other embodiments and aspects of the invention are described in detail herein and are considered a part of the claimed inventions. Other embodiments and aspects can be understood with reference to the following detailed description, accompanying drawings, and claims.

### BRIEF DESCRIPTION OF THE FIGURES

Reference will now be made to the accompanying tables and drawings, which are not necessarily drawn to scale, and wherein:

FIG. 1 is a diagram of an illustrative buffered optical fiber according to an example embodiment of the invention.

FIG. 2 is a block diagram of an illustrative coating line according to an example embodiment of the invention.

FIG. 3 is a flow diagram of an example method according to an example embodiment of the invention.

### DETAILED DESCRIPTION OF THE INVENTION

Embodiments of the invention will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Example embodiments of the invention include an optical fiber buffer that may be stiff, transparent, and made from UV curable acrylate. According to an example embodiment of the invention, the tight buffer may include a higher modulus material, which can provide benefits in jumper performance as well as macrobending loss of fiber-to-the-home (FTTH) cable. For example, in certain embodiments, the elastic modulus of the buffer material can be greater than 40,000 psi. In other certain embodiments of the invention, the buffer elastic modulus can be greater than 70,000 psi. According to certain implementations of the invention, performance advantages of cordage and FTTH drop cables, may be preserved while increasing production, reducing scrap, and conserving capital.

According to an example embodiment of the invention, the buffer may be deposited directly on colored 250 micron fiber without any tertiary release layer. In an example embodiment, a release layer may be included but is not essential. According to example embodiments of the invention, a tertiary color layer may be deposited on the secondary of an optical fiber by a coloring machine. In another example embodiment, the secondary layer may incorporate a colorant. In example embodiments of the invention the buffer layer may be clear so that the color associated with the tertiary layer or colored secondary layer may be visually identified through the clear buffer.

Visually identifying fiber breaks can be very difficult when the buffer coating is opaque. According to certain example embodiments of the invention, the use of the clear buffer coating may allow easy identification of fiber breaks. For example, light from a visible laser (for example, red visible light from a helium-neon laser) may be coupled into the optical fiber, and a break may be identified by the visible light scattering and/or leaking out of the fiber at the break.

According to example embodiments of the invention, the elastic modulus of the buffer material may be 75,000 psi. In certain example embodiments of the invention, the elastic modulus of the buffer material may be higher than the elastic modulus of Nylon 12, which can have an elastic modulus of about 218,000 psi. According to example embodiments of the invention, optical fibers having the acrylate buffer with the high elastic modulus (or stiffness) can provide mechanical reliability for use in jumpers and cables, and it may help resist buckling during mating of optical connectors. According to example embodiments of the invention, during termination, a portion of the fiber end may slide into the jacket without buckling. According to example embodiments, the stiffness of the buffer can help reduce bending attenuation or even fiber breaks that can occur during termination.

Example embodiments of the invention may also provide low macrobending attenuation for use with ultra-bend-insensitive drop cables. Tables 1 and 2 below indicate measured attenuation performance as a function of temperature for 50 micron fiber with buffer coatings, according to example embodiments of the invention, and in comparison to other buffer coatings. According to the measured data, example embodiments of the invention provide UV buffer optical fiber that has superior low-temperature attenuation performance when compared to other non-halogen tight buffer systems.

According to an example embodiment, fibers utilizing the invention may be utilized in outdoor-indoor cables incorporating tight buffered fiber to support robust connectorization. Such cables may be installed in cell tower applications, where the optical cabling can run from the base station to the antenna on the tower. In example embodiments, the runs may be long, and it may be desirable to use flame-retardant cables as some of the cable run may be inside a building or some other structure. One example application may utilize 50 micron multimode optical fiber with low attenuation throughout the temperature range from −40 C to 70 C. The relevant industry standard in North America is the ICEA-S-104-696 standard, “Standard for Indoor-Outdoor Optical Fiber Cable”. The temperature cycling requirement for this standard is that multimode fiber cables must have attenuation less than or equal to 0.60 dB/km when cycled twice between −40 C and 70 C per the TIA/EIA-455-3A-01 test procedure for temperature cycling of optical cables.

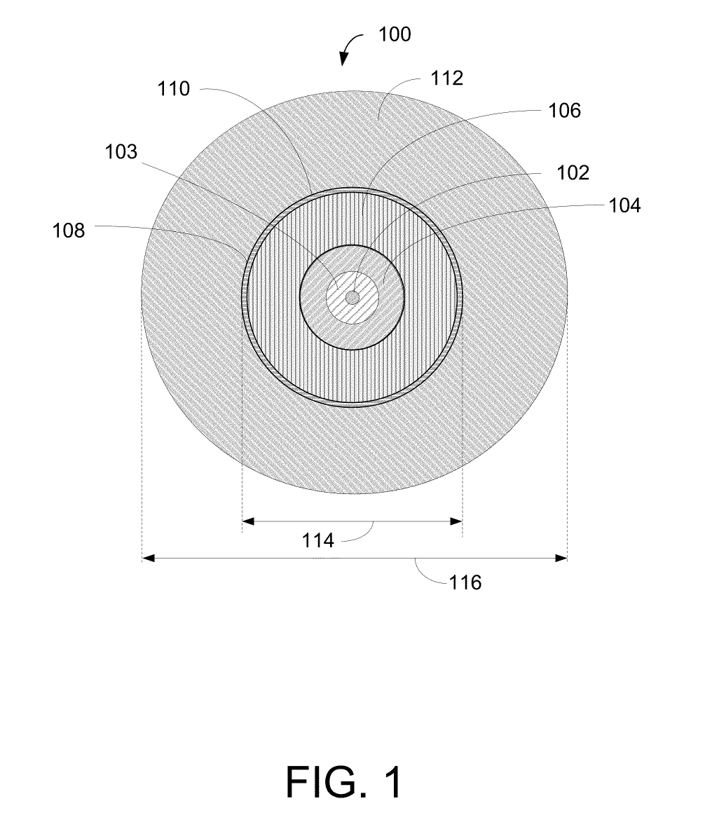

FIG. 1 illustrates an example buffered optical fiber 100, according to an example embodiment of the invention. The optical fiber 100 may include a core 102, a cladding 103 surrounding the core 102, a primary layer 104 surrounding the cladding 103, a secondary layer 106 surrounding the primary layer 104. In certain example embodiments, the optical fiber 100 may include an optional tertiary layer 108, which may be colored or colorless. In other example embodiments, the optical fiber 100 may include a release layer or surface 110.

In accordance with certain example embodiments of the invention, a clear or translucent buffer 112 surrounds the optical fiber 100. In one embodiment, the buffer 112 may have an inner diameter 114 that is equal to an outer diameter of the secondary layer 106. In another example embodiment, the buffer 112 may have an inner diameter 114 that is equal to an outer diameter of the tertiary layer 108. In another example embodiment, the buffer 112 may have an inner diameter 114 that is equal to an outer diameter of the release layer 110. In an example embodiment, the buffer 112 may have an outer diameter 116 that can be approximately 900 microns. In other example embodiments, the buffer 112 may have an outer diameter 116 that can be in a range of about 500 microns to about 1000 microns. In example embodiments, the buffer includes a polyester/polyether polyol aliphatic urethane acrylate.

According to example embodiments, the buffered optical fiber 100 includes a tertiary layer 108 surrounding the secondary layer 106, wherein the tertiary layer 108 includes a color for identification. In example embodiments, the color associated with the tertiary layer 108) is visible through the buffer 112. According to example embodiments, the buffer 112 includes vinyl/acrylate monomers. In example embodiments, the buffer 112, when cured, is strippable from the optical fiber with a strip force in the range of about 0.8 lbs to about 1.8 lbs. for a 1-inch strip length. In example embodiments, the buffer 112 has a molecular weight of about 7,000 g/mol.

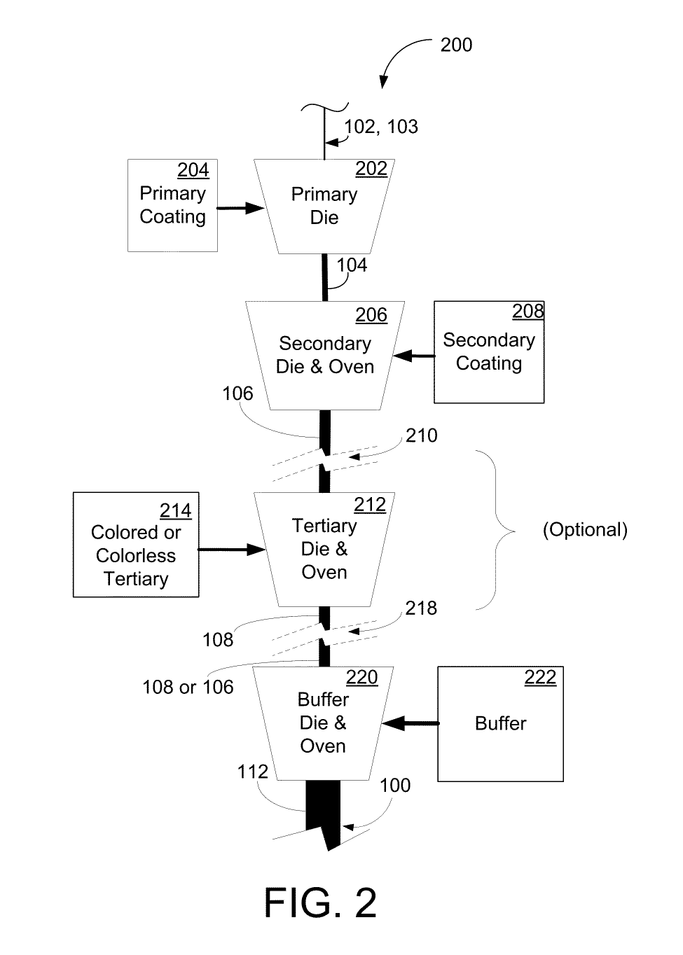

FIG. 2 depicts block diagram of an example processing line 200 for coating the optical fiber. For example, a bare optical fiber (which may include a core as in 102 of FIG. 1, and cladding 103 as in FIG. 1) may be coated with a primary coating 204 upon passing through a primary die 202. The fiber having the primary coating (as in 104 of FIG. 1.) may then be coated with a secondary coating 208 upon passing through a secondary die 206. In example embodiments, the secondary coating may include color, or it may be colorless. In example embodiments, the secondary coating may include release agents to assist in removal of subsequent coatings. In one example, the fiber having the primary and secondary coating (as in 106 of FIG. 1) may be cured and spooled 210 for later processing, or it may continue to a tertiary die 212 where a colored or colorless tertiary layer 214 may coat the fiber having the primary and secondary coating. In an example embodiment, the fiber having the primary, secondary, and tertiary coating (as in 108 of FIG. 1) may be cured and spooled 218 for later processing or it may continue to a buffer die 220 where a buffer 222 may be applied to the outer layer. In other example embodiments, the fiber having the primary and secondary coating (as in 106 of FIG. 1) may bypass the tertiary die 212 and may have the buffer 222 applied to the outer layer. In an example embodiment, the fiber with the buffer applied may be cured, for example, using UV curing ovens, to produce the buffered optical fiber (as in 112 of FIG. 1).

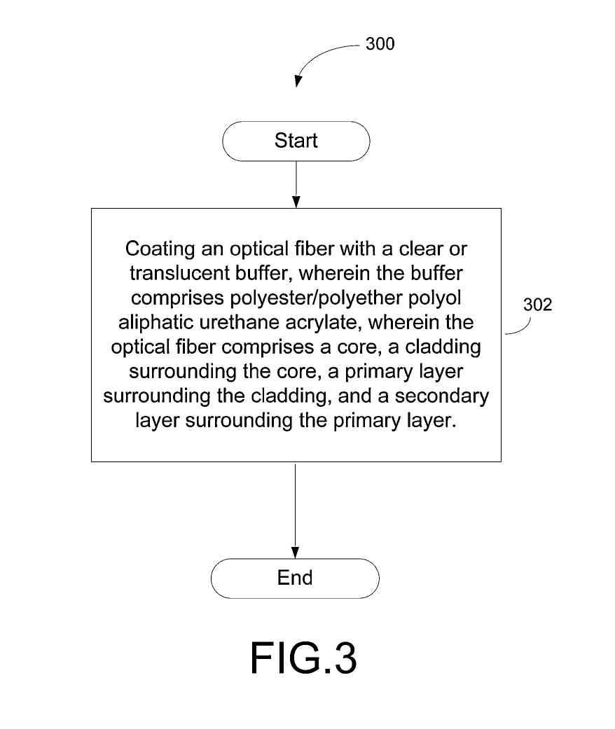

An example method 300 for coating an optical fiber will now be described with reference to the flowchart of FIG. 3. The method 300 starts in block 302 and includes coating an optical fiber with a clear or translucent buffer, wherein the buffer comprises polyester/polyether polyol aliphatic urethane acrylate, wherein the optical fiber comprises a core, a cladding surrounding the core, a primary layer surrounding the cladding, a secondary layer surrounding the primary layer. The method 300 ends after block 302.

According to an example embodiment, the buffer 112 for coating the optical fiber, when cured, is strippable from the optical fiber with a strip force in the range of about 0.8 lbs to about 1.8 lbs. for a 1-inch strip length. In an example embodiment, the buffer 112 for coating the optical fiber has a molecular weight of about 7,000 g/mol. In an example embodiment, the buffer 112 for coating the optical fiber includes up to about 9 percent by weight of a release agent. In an example embodiment, the release agent can be non-reactive. For example, the release agent may include silicone. In another example embodiment, the release agent may be reactive. In an example embodiment, the buffer 112 for coating the optical fiber, when cured, comprising an elastic modulus greater than 40,000 psi. In an example embodiment, the buffer 112 for coating the optical fiber, when cured, comprising an elastic modulus greater than 70,000 psi.

Certain example embodiments of the invention include an ultraviolet curing liquid coating composition. The composition can include polyester/polyether polyol aliphatic urethane acrylate, which when cured with ultraviolet light in the presence of a photoinitiator sensitive to the ultraviolet light, provides a clear or translucent buffer coating for optical fiber comprising an elastic modulus greater than 40,000 psi. In other example embodiments, the clear or translucent buffer coating, when cured has an elastic modulus greater than 70,000 psi. In example embodiments, the coating composition can include vinyl/acrylate monomers. In example embodiments, the coating composition, when cured, is strippable from the optical fiber with a strip force in the range of about 0.8 lbs to about 1.8 lbs. In example embodiments, coating composition can have a molecular weight of about 7,000 g/mol. In example embodiments, the coating composition may include up to about 9 percent by weight of a release agent. The release agent may be non-reactive or reactive.

As indicated in Table 1 and Table 2 below, you can see in the attached file, tight buffer has low absolute attenuation at room temperature and low added attenuation throughout the temperature range from −40 C to 70 C. The nylon 12/polyolefin dual layer buffer (as described in U.S. Pat. No. 5,684,910 to Chapin et al) has low attenuation at room temperature and 70 C, but unacceptable attenuation at −40 C. The nylon is stiff, with a glass transition temperature of 41 C, and as it contracts below room temperature, and the fiber may undergo microbending, which may result in high attenuation. In contrast the LSZH buffer has high attenuation as-made at 23 C. The added attenuation is lower when cycled but at all points, the absolute attenuation is higher. This is likely due to inherently high microbending loss in this kind of system as the LSZH buffer contains approximately 50 wt % metal hydrate filler to achieve flame retardancy.

The plasticized PVC buffer shows relatively low attenuation as-made and adequate attenuation during temperature cycling. However, polyvinyl chloride is not an option in true non-halogen cabling. More and more, global customers are requiring or pushing for non-halogen solutions.

The data in Tables 1 and 2 indicate that the 50-micron fibers, made with UV cured acrylate tight buffer, according to example embodiments of the invention, provide a unique and advantageous combination of low absolute attenuation, low added attenuation during temperature cycling, and a non-halogen formulation. One possible explanation for the attenuation is the extremely low thermal expansion and contraction of the tight buffer coating due to its cross-linked molecular structure.

TABLE 1

| | 23° C. | | −40° C. #1 | | 70° C. #1 | | −40° C. #2 | | 70° C. #2 | |
|---|---|---|---|---|---|---|---|---|---|---|
| | Loss (dB/km) | | Loss (dB/km) | | Loss (dB/km) | | Loss (dB/km) | | Loss (dB/km) | |
| Sample | 850 | 1300 | 850 | 1300 | 850 | 1300 | 850 | 1300 | 850 | 1300 |
| Or | 2.164 | 0.481 | 2.235 | 0.556 | 2.167 | 0.437 | 2.212 | 0.562 | 2.146 | 0.439 |
| Gr | 2.146 | 0.465 | 2.142 | 0.480 | 2.110 | 0.460 | 2.100 | 0.492 | 2.113 | 0.473 |
| Br | 2.241 | 0.551 | 2.343 | 0.668 | 2.171 | 0.463 | 2.343 | 0.645 | 2.186 | 0.470 |
| Sl | 2.291 | 0.549 | 2.356 | 0.624 | 2.169 | 0.507 | 2.201 | 0.594 | 2.160 | 0.514 |
| Wh | 2.264 | 0.514 | 2.258 | 0.538 | 2.166 | 0.486 | 2.175 | 0.539 | 2.172 | 0.488 |
| Nylon | 2.101 | 0.455 | 2.987 | 1.349 | 2.101 | 0.450 | 3.275 | 1.658 | 2.104 | 0.455 |
| 12/polyolefin | | | | | | | | | | |
| dual layer | | | | | | | | | | |
| LSZH | 2.599 | 0.932 | 2.621 | 0.979 | 2.69 | 1.008 | 3.042 | 1.392 | 2.946 | 1.225 |
| Plasticized semi- | 2.082 | 0.6 | 2.36 | 0.687 | 2.263 | 0.553 | 2.196 | 0.532 | 2.304 | 0.588 |
| flexible PVC | | | | | | | | | | |

TABLE 2

| | Added loss, −40 C. #1 | | Added loss, 70 C. #1 | | Added loss, −40 C. #2 | | Added loss, 70 C. #2 | |
|---|---|---|---|---|---|---|---|---|
| | (dB/km) | | (dB/km) | | (dB/km) | | (dB/km) | |
| Sample | 850 | 1300 | 850 | 1300 | 850 | 1300 | 850 | 1300 |
| Or | 0.071 | 0.075 | 0.003 | −0.044 | 0.048 | 0.081 | −0.018 | −0.042 |
| Gr | −0.004 | 0.015 | −0.036 | −0.005 | −0.046 | 0.027 | −0.033 | 0.008 |
| Br | 0.102 | 0.117 | −0.070 | −0.088 | 0.102 | 0.094 | −0.055 | −0.081 |
| Sl | 0.065 | 0.075 | −0.122 | −0.042 | −0.090 | 0.045 | −0.131 | −0.035 |
| Wh | −0.006 | 0.024 | −0.098 | −0.028 | −0.089 | 0.025 | −0.092 | −0.026 |
| Nylon | 0.886 | 0.894 | 0.000 | −0.005 | 1.174 | 1.203 | 0.003 | 0.000 |
| 12/polyolefin | | | | | | | | |
| dual layer | | | | | | | | |
| LSZH | 0.022 | 0.047 | 0.091 | 0.076 | 0.443 | 0.460 | 0.347 | 0.293 |
| Plasticized semi- | 0.278 | 0.087 | 0.181 | −0.047 | 0.114 | −0.068 | 0.222 | −0.012 |
| flexible PVC | | | | | | | | |

According to example embodiments, certain technical effects can be provided, such as creating certain optical fibers for which the buffer coating may be applied at line speeds of approximately 300 meters per minute or more. According to example embodiments, certain technical effects can be provided, such as creating certain optical fibers for which the buffer coating may be applied using a converted optical fiber coloring line. Example embodiments of the invention can provide the further technical effects of creating multi-fiber cables wherein the fiber can be easily identified by applying a transparent coating over colored fibers. Example embodiments of the invention can provide the further technical effects of creating fibers having a strip force that is compliant with industry-standard requirements for tight buffers.

As desired, embodiments of the invention may include the buffer optical fiber 100 with more or less of the components illustrated in FIG. 1. While certain embodiments of the invention have been described in connection with what is presently considered to be the most practical and various embodiments, it is to be understood that the invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the invention, including the best mode, and also to enable any person skilled in the art to practice certain embodiments of the invention, including making and using any devices or systems and performing any incorporated methods. The patentable scope of certain embodiments of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The claimed invention is:

1. A buffered optical fiber comprising:
an optical fiber comprising a core, a cladding surrounding the core, a primary layer surrounding the cladding, a secondary layer surrounding the primary layer; and
a clear or translucent buffer that surrounds the optical fiber, wherein the buffer comprises polyester/polyether polyol aliphatic urethane acrylate, and wherein the buffer comprises an elastic modulus greater than 40,000 psi.

2. The buffered optical fiber of claim 1, further comprising a tertiary layer surrounding the secondary layer, wherein the tertiary layer comprises a color for identification.

3. The buffered optical fiber of claim 2, wherein the color associated with the tertiary layer is visible through the buffer.

4. The buffered optical fiber of claim 1, wherein the buffer further comprises vinyl/acrylate monomers.

5. The buffered optical fiber of claim 1, wherein the buffer is strippable from the optical fiber with a strip force in the range of about 0.8 lbs to about 1.8 lbs. for a strip length of 1-inch.

6. The buffered optical fiber of claim 1, wherein the buffer comprises a molecular weight of about 7,000 g/mol.

7. The buffered optical fiber of claim 1, wherein the buffer further comprises up to about 9 percent by weight of a release agent.

8. The buffered optical fiber of claim 1, wherein the buffer comprises an outer diameter up to about 900 microns.

9. An ultraviolet curing liquid coating composition comprising:
polyester/polyether polyol aliphatic urethane acrylate, which when cured with ultraviolet light in the presence of a photoinitiator sensitive to the ultraviolet light, provides a clear or translucent buffer coating for optical fiber comprising an elastic modulus greater than 40,000 psi.

10. The coating composition of claim 9, which when cured comprises an elastic modulus greater than 70,000 psi.

11. The coating composition of claim 9, further comprising vinyl/acrylate monomers.

12. The coating composition of claim 9, which when cured, is strippable from the optical fiber with a strip force in the range of about 0.8 lbs to about 1.8 lbs. for a strip length of 1-inch.

13. The coating composition of claim 9, further comprising a molecular weight of about 7,000 g/mol.

14. The coating composition of claim 9, further comprising up to about 9 percent by weight of a release agent.

15. The coating composition of claim 9, which when cured, provides a buffer having an outer diameter up to about 900 microns.

16. A method for coating an optical fiber, the method comprising:
coating an optical fiber with a clear or translucent buffer, wherein the buffer comprises polyester/polyether polyol aliphatic urethane acrylate, wherein the optical fiber comprises a core, a cladding surrounding the core, a primary layer surrounding the cladding, a secondary layer surrounding the primary layer.

17. The method of claim 16, wherein the buffer for coating the optical fiber further comprises vinyl/acrylate monomers.

18. The method of claim 16, wherein the buffer for coating the optical fiber, when cured, is strippable from the optical fiber with a strip force in the range of about 0.8 lbs to about 1.8 lbs. for a strip length of 1-inch.

19. The method of claim 16, wherein the buffer for coating the optical fiber comprises a molecular weight of about 7,000 g/mol.

20. The method of claim 16, wherein the buffer for coating the optical fiber comprises up to about 9 percent by weight of a release agent.

21. The buffered optical fiber of claim 1, wherein coating an optical fiber with a buffer comprises applying a buffer with an outer diameter up to about 900 microns.

22. The method of claim 16, wherein the buffer for coating the optical fiber, when cured, comprising an elastic modulus greater than 40,000 psi.

23. The method of claim 16, wherein the buffer for coating the optical fiber, when cured, comprising an elastic modulus greater than 70,000 psi.
